(19) United States
(12) Patent Application Publication
(10) Pub. No.: US 2022/0248896 A1
(43) Pub. Date: Aug. 11, 2022

(54) BEVERAGE SYSTEM

(71) Applicant: EVVE INC., GRAND RAPIDS, MI (US)

(72) Inventor: JIMMY-QUANG VIET DOAN, GRAND RAPIDS, MI (US)

(73) Assignee: EVVE INC., GRAND RAPIDS, MI (US)

(21) Appl. No.: 17/667,175

(22) Filed: Feb. 8, 2022

Related U.S. Application Data
(60) Provisional application No. 63/147,524, filed on Feb. 9, 2021.

(51) Int. Cl. A47J 31/36; A47J 31/06; B65D 85/804

(52) U.S. Cl. CPC A47J 31/369; A47J 31/0673; B65D 85/8046; A47J 31/0642

(57) ABSTRACT

A beverage system having a pod and a brewer, the brewer including a closure movable between an open position and a closed position. A chamber included in the closure that is defined by a set of walls including a pair of sidewalls. The pod includes a holder and a wrapper fully enclosing the holder. An exterior of the pod is defined by the wrapper and when the pod is received in the brewer the exterior is punctured.

### CROSS-REFERENCE TO RELATED APPLICATIONS

This application claims priority to U.S. Provisional Application Ser. No. 63/147,524, filed Feb. 9, 2021, the contents of which are incorporated herein by reference.

### TECHNICAL FIELD

The present disclosure relates to a device for making a beverage.

### BACKGROUND

Consumer demand for gourmet and specialty coffee has grown substantially. Consumers demand home brewing methods that produce specialty coffee comparable to that produced by specialty coffee shops. Brewing methods must be able to have greater control of several brewing parameters such as pressure, brew cycle time, brew volume, filtration, amount of coffee grounds and water temperature.

### BRIEF DESCRIPTION OF THE DRAWINGS

FIG. 1 illustrates a schematic of a brewing system, including a pod, a brewer, and a server, with a smart device.

FIG. 2 illustrates an exploded version of the pod of FIG. 1 including a wrapper, a holder, and a filter.

FIG. 3 illustrates the holder from FIG. 2 in a pre-folded position according to an aspect of the disclosure herein.

FIG. 4 illustrates a flap holder, a variation of the holder from FIG. 2 according to an aspect of the disclosure herein.

FIG. 5 illustrates a two-part holder, another variation of the holder from FIG. 2 according to another aspect of the disclosure herein.

FIG. 6 illustrates an enclosed holder, another variation of the holder from FIG. 2 according to yet another aspect of the disclosure herein.

FIG. 7 illustrates a sealed holder, yet another variation of the holder from FIG. 2 according to yet another aspect of the disclosure herein.

FIG. 8 illustrates a box holder, another variation of the holder from FIG. 2 according to an aspect of the disclosure herein.

FIG. 9 illustrates a reversible holder, another variation of the holder from FIG. 2 according to yet another aspect of the disclosure herein.

FIG. 10 illustrates an omni-directional holder, yet another variation of the holder from FIG. 2 according to another aspect of the disclosure herein.

FIG. 11 illustrates a perspective view of the wrapper encasing the omni-directional holder of FIG. 10 according to an aspect of the disclosure herein.

FIG. 12 illustrates a tall pod, a variation of the pod from FIG. 2 according to an aspect of the disclosure herein.

FIG. 13 illustrates a sample package for shipping a plurality of pods.

FIG. 14 illustrates a front view of the sample package from FIG. 3.

FIG. 15 illustrates a perspective view of the brewer from FIG. 1 in an opened position.

FIG. 16 illustrates a schematic top down view of a portion of the brewer from FIG. 15 with a set of cutters.

FIG. 17 illustrates a schematic side view of the brewer from FIG. 15 in the open position.

FIG. 18 illustrates a schematic side view of the brewer from FIG. 15 in a closed position.

FIG. 19 illustrates a schematic side view of the brewer from FIG. 15 in the closed position with the tall pod in place.

FIG. 20 illustrates a schematic front view of the brewer from FIG. 17 in the open position.

FIG. 21 illustrates a schematic front view of the brewer from FIG. 18 in the closed position.

FIG. 22 illustrates a schematic side view of variation of a chamber for the brewer from FIG. 15 in the open position.

FIG. 23 illustrates a schematic side view of the chamber from FIG. 22 in the closed position.

FIG. 24 illustrates a representative sequence of operation for the brewer in multiple positions, a ready, a receiving, and a prepped position.

FIG. 25 illustrates a cross-sectional schematic view of the pod and the base portion taken along line XXV-XXV of FIG. 24 in the prepped position.

FIG. 26 illustrates a cross-sectional schematic view of the pod and the base portion taken along line XXVI-XXVI of FIG. 24 in the ready position.

FIG. 27 illustrates a schematic flow of passing water through the pod of FIG. 1.

FIG. 28 illustrates a variation of the cross-sectional schematic view of FIG. 23 of the pod and base portion with a set of needles according to another aspect of the disclosure herein.

FIG. 29 illustrates a cross-sectional schematic view of the holder of FIG. 11 with another variation of the set of needles of the brewer according to another aspect of the disclosure herein.

FIG. 30 illustrates a variation of the pod of FIG. 1 and the base portion in cross-section in the prepped position.

FIG. 31 illustrates the pod and the base portion from FIG. 28 in the ready position according to another aspect of the disclosure herein.

FIG. 32 illustrates a schematic view of a representative path water can travel in the brewer according to an aspect of the disclosure herein.

FIG. 33 illustrates a first representative orientation for the set of cutters according to an aspect of the disclosure herein.

FIG. 34 illustrates a second representative orientation for the set of cutters according to another aspect of the disclosure herein.

FIG. 35 illustrates a centralized pod, a variation of the pod of FIG. 1, according to another aspect of the disclosure herein.

FIG. 36 illustrates the centralized pod from FIG. 35 in a wrapper and illustrating a representative water path through the centralized pod.

FIG. 37 illustrates another representative path for water traveling through the pod according to another aspect of the disclosure herein.

### DETAILED DESCRIPTION

Aspects of the disclosure described herein are directed to a brewing system. More specifically, a brewer and single use pod. For purposes of illustration, the present disclosure will be described with respect a brewing system for making coffee. It will be understood, however, that aspects of the disclosure described herein are not so limited and may have general applicability with respect to other brewed beverages or beverage brewing devices and systems, including but not limited to tea and espresso.

Plastics pollution has generated great scrutiny of single-use plastic. Plastics from food packaging account for a large amount of the plastic used and disposed of. The scale of the damage plastic waste has on our oceans is profound. The smallest pieces, called microplastic, are small enough to be consumed by ocean animals and is now showing up in our food and water supply. Sustainability and the movement to eliminate plastic waste, especially from single-use plastic, is driving fundamental behavioral changes among consumers and the consumer-packaged goods (CPG) industry.

Typical single-serve coffee systems use a single size pod containing enough coffee for a cup of coffee. They are not able to hold enough coffee grounds, beverage materials, or the like, for large travel mugs or carafes without significantly diluting the coffee. Milk, cocktails, liquid mixes, vitamin drinks or nutraceuticals are examples of other beverage materials. One of the benefits associated with aspects of the disclosure herein includes a brewer that is adaptable to pods of multiple sizes with only a single pod dimension change. The brewer changes in a single dimension to receive and provide a snug fit for the pod, when the pod described herein increases volume by changing a single dimension. In one non-limiting example, the single dimension can include the height dimension.

The brewing system described herein provides more controllable extraction of grounds for brewing. As used herein, “extraction” is the process of dissolving the soluble portion of the beverage material, into a solution, by way of non-limiting example, coffee. “Uneven extraction,” as used herein, relates to when a sub-portion of the grounds are extracted more or less than others. Uneven extraction can create an undesirable coffee taste. The brewing system described herein enables an “even” extraction (as opposed to uneven, as used herein) by ensuring a uniform flow of water over a larger comparable sub-portion of the grounds, including up to every portion of the grounds, during the brewing process. In conventional brewing pods, by contrast, water will often create vortices or only flow within narrower channels (a process known as “channeling”) producing non-uniform water flow and uneven extraction. Beverage brewing including controlling the even extraction of coffee grounds to precise levels is desirable from a user, a flavor, or a consistency preference.

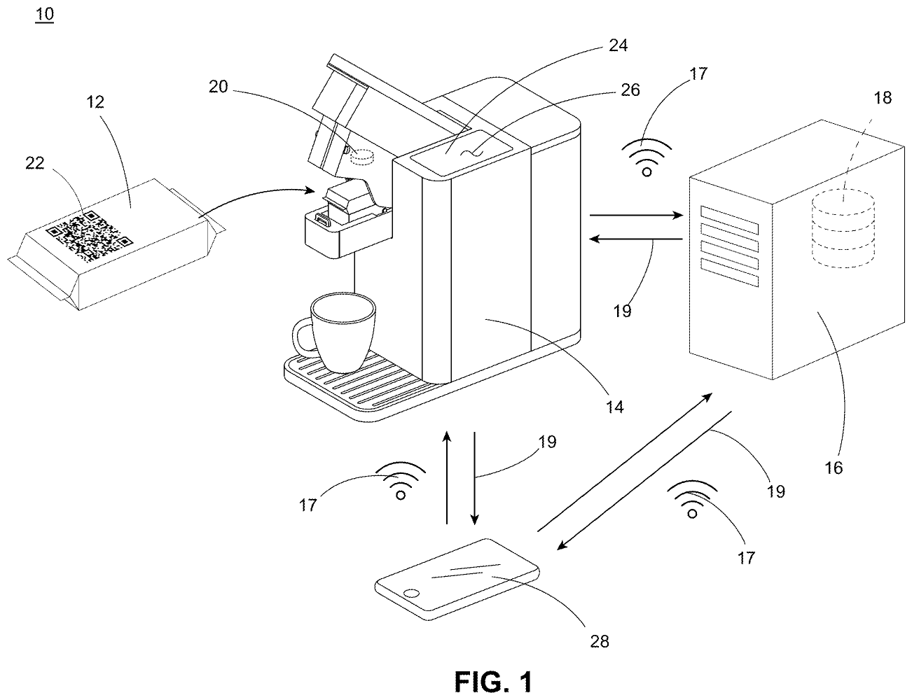

FIG. 1 illustrates a beverage system 10 including a pod 12 and a brewer 14. In some forms, the beverage system 10 can further include a server 16 for storing data 18. The brewer 14 can include a reader 20, by way of non-limiting example a QR reader, a barcode reader, a near field, or other type of reader configured to read information 22 located on the pod 12. The brewer 14 can further include a user interface 24 including a display screen 26 configured to share information associated with each pod 12 and to control the brewer 14. The user interface 24 can be used to interact with and control the brewer 14 as well as present information detected from the pod 12. It is contemplated that the brewer 14 includes technology that enables communication with the server 16 by way of a network, such as the Internet, as illustrated by a wireless communication symbol 17. The data 18 can be communicated or transmitted back and forth as illustrated by arrows 19. The data 18 can include information the brewer collected from the pods 12, and any other information collected by the beverage system 10. It is further contemplated that the brewer 14 is controlled by an interface or application stored in a smart device 28, by way of non-limiting example a smartphone or tablet.

Over time the server 16 can form a user taste profile. Further, data 18 stored can include, but is not limited to, beverages a user may like or prefer, beverage renewal subscriptions, advertising or marketing data, features and specials, local roasters, videos, regional beverage information, beverage of the week, alerts when it is time to reorder, sample packets available, celebrity beverage pics, or the like.

The user interface 24 can be located, by way of non-limiting example on a top of the brewer 14, as illustrated. It is also contemplated that the user interface 24 is located on the smart device 28. The display screen 26 of the user interface 24 can be a large touch screen capable of or configured for user interaction. It is contemplated that the user interface 24 can display beverages the user may like, beverage renewal subscriptions, advertising or marketing data, features and specials, local roasters, videos, regional beverage information, beverage of the week, alerts when it is time to reorder, sample packets available, celebrity beverage pics, or the like.

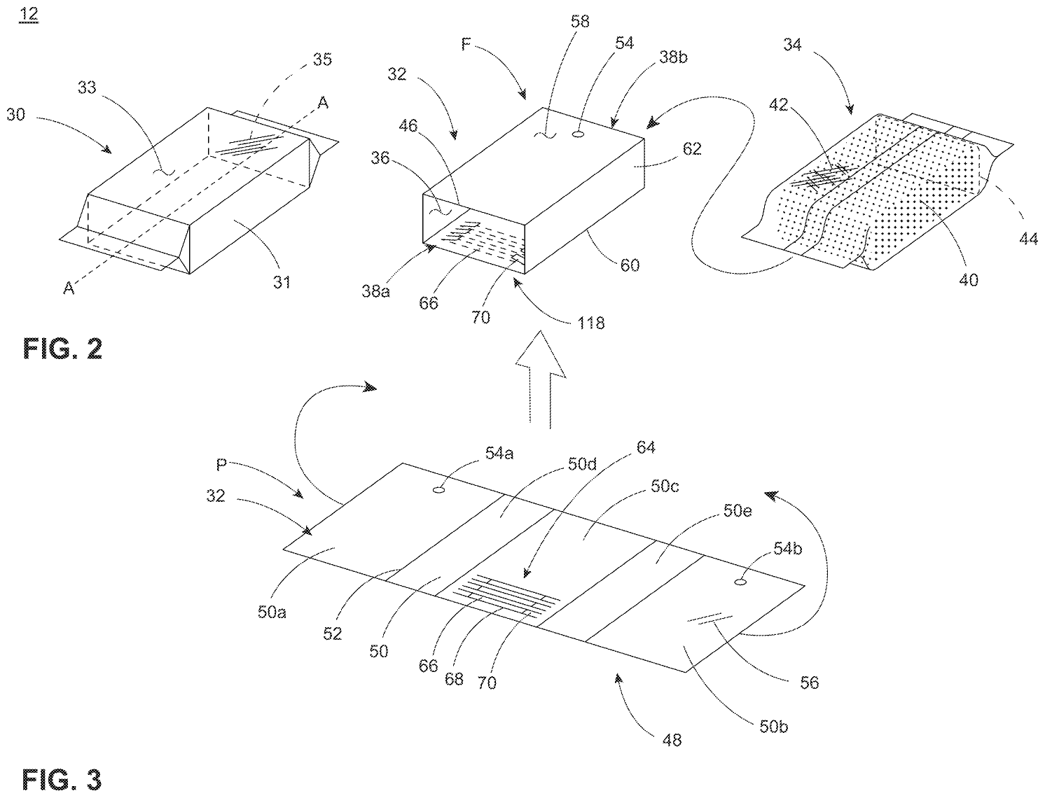

FIG. 2 is an enlarged view of the pod 12 and corresponding parts thereof. The pod 12 can include three separate parts, a wrapper 30, a holder 32, and a pouch 34. The pouch 34 can be received within the holder 32 and both can be fully enclosed within the wrapper 30 to form the pod 12. The holder 32 is rigid and can have an extruded shape. By extruded shape, the holder can define a shape that includes a single shape extended along a longitudinal axis, shown as axis A-A. For example, the holder 32 can have a substantially cuboid shape such that a rectangle is extruded along the longitudinal axis A-A. The pod 12 can also have a substantially cuboid shape having six pod facets or pod walls 31. The pod 12 can include additional facets or pod walls 31.

The wrapper 30 can be formed from a film 33 made from materials traditionally used to package food, i.e. flexible films. It is further contemplated that a plant-based flexible film can be used to wrap the holder 32 when the pod 12 is fully formed, i.e. the pouch 34 is received within the holder 32 which is wrapped in the wrapper 30. The wrapper 30 can be a single piece that is unattached to any other component of the pod 12. This allows for selection and engineering of the film 33 material independently without affecting any other components since they are not joined. The wrapper 30 forms a completely sealed enclosure that creates a barrier from air, light and moisture.

The holder 32 can be folded from a pre-folded position (P) illustrated in FIG. 3 to a folded position (F) illustrated in FIG. 2. Reference to both FIGS. 2 and 3 is helpful in the following description of the holder 32. When folded, the holder 32 can define an interior 36 with open ends 38a, 38b. The pouch 34 can be received in one of the open ends 38a, 38b when the pod 12 is assembled. In an event where the pod 12 is used for other beverages such as powdered milk, cocktails, liquid mixes, vitamin drinks or nutraceuticals, the pouch 34 is not necessarily needed.

The holder 32 serves as a rigid or structural component to maintain the shape of the pod 12. The holder 32 defines an interior volume and maintains the overall shape of the pod independent of the contents inside. Rather than having an external rigid component for structure or interfacing with the brewer, the pod 12 includes an internal component, i.e. the holder 32, for creating a rigid structure. While some pods include vacuum packed grounds that can provide rigidity, when brewed, non-limiting aspects of the disclosure can be included wherein vacuum-packed grounds change shape and size removing any rigid structure they initially provided. The holder 32 described herein provides a consistent rigid structure for the pod 12.

The pouch 34 can be made out of any material capable of filtering beverage materials 40, such as coffee grounds, from the brewed solution. By way of non-limiting example paper filter, spunbond polypropylene, or biodegradable non-woven material can be included as filter material of the pouch. The beverage material 40 is completely contained within a sealed filter 42 forming the pouch 34. The sealed filter 42 and holder 32 can be sized to match. A pouch perimeter 44 of the pouch 34 and an internal perimeter 46 of the holder 32 can be close to matching. It is contemplated that the pouch perimeter 44 is slightly smaller than the internal perimeter 46. In operation, the close value of the perimeters 44, 46 prevents water from seeping around pouch 34.

It should be understood that each of the wrapper 30, holder 32, and pouch 34 of the assembled pod 12 are separate from each other. In manufacturing of the pod 12 it is beneficial that each part is easily manufactured separately and then assembled together without requiring joining between the three parts to form the pod 12. Furthermore, the cuboid shape enables simple molds and parts for manufacturing. More specifically, the parts can be manufactured from sheet material rather than requiring thermoformed plastic parts. No components of the assembly are joined to each other. All components of the pod are completely contained within, and not attached to, the wrapper 30. More specifically, when assembled, the holder 32 is completely contained within the wrapper 30 at all times, even during the brewing operation. Further, the pod 12 as described herein requires zero molded plastic parts. The wrapper 30 forms a barrier to keep the beverage material 40 fresh. Simultaneously the wrapper 30 is also the component that contains the flow of water during the brewing process. Therefore, a single component is utilized to keep internal ingredients fresh and contain water flow inside the pod during the brewing operation.

The holder 32 can be formed from a flat form 48, by way of non-limiting example paperboard or a paper-based material. It is contemplated that the flat form 48 can be made of other rigid materials such as plastic or aluminum molded into a cuboid shape. In one non-limiting example, the flat form 48 can include five portions 50 separated by folding lines 52. Two end portions 50a, 50b can each include apertures 54a, 54b. When the flat form 48 is folded along the folding lines 52, the apertures 54a, 54b can align to form a single common aperture 54. In an exemplary flat form 48, one side forming the interior 36 of the holder 32 can be coated with a moisture resistant coating 56, by way of non-limiting example, a plant-based coating. When folded, the two end portions 50a, 50b form a top 58 of the holder 32. The two end portions 50a and 50b can be heat sealed to each other to maintain the folded shape of the holder 32.

A third portion 50c forms a bottom 60 of the holder 32 extending between flat sides 62 defined by fourth and fifth portions 50d, 50e. The flat sides 62 can be parallel to each other. The third portion 50c can include a pattern 64 having at least one opening 66, illustrated as three slots in dashed line. The at least one opening 66 is open to the interior 36 of the holder 32. The at least one opening 66 can include elongated perforations 68 extending laterally between flat sides 62. The elongated perforations 68 can include at least one safeguard device, illustrated as tabs 70 proximate the flat sides 62. When folded, the flat sides 62 can be parallel to each other. While illustrated as three openings 66, different patterns are contemplated including, but not limited to, openings extending longitudinally rather than horizontally with respect to the wrapper or a collection of apertures. The different patterns can be engineered to control (e.g. to increase or to relieve) pressure inside the pod during a brewing process. By way of non-limiting example, pressure in a coffee brewing process creates different flavors, and different patterns can be associated with various flavor profiles, for example bold, medium, and mild. The at least one opening 66 can define at least a portion of a fluid outlet 118 that allows liquid to exit pouch 34 through holder 32. The size, shape, placement, and quantity of openings 66 can be varied to control pressure in the interior 36 during the brewing process. Increasing the total area of openings 66 decreases pressure inside the pod during the brewing operation. Altering pressure during the brewing process changes flavors extracted from the coffee.

It should be understood that while illustrated as five portions 50, the holder 32 can be made from molded plastic into a shape like an extruded rectangular tube, or with paper board having two halves that are joined together as just two examples.

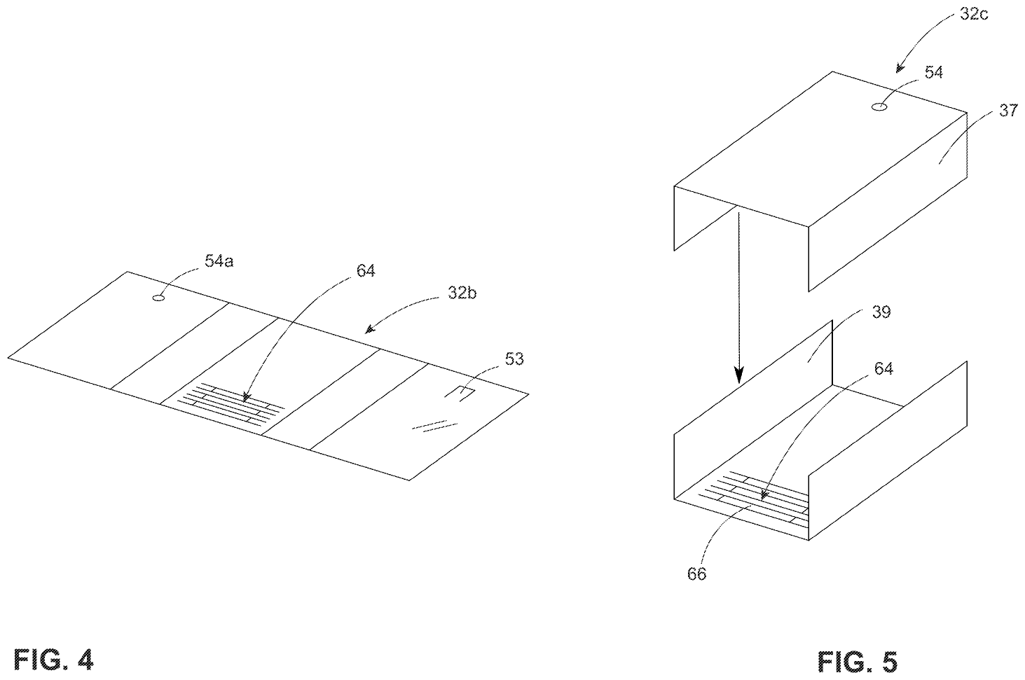

FIGS. 4-10 illustrate variations of the holder 32 described herein. Some numerical indicators have been removed for clarity. It should be understood that the parts associated with the holder 32 previously described are attributed to the following variations unless otherwise noted.

FIG. 4 illustrates a flap holder 32b, a variation of the holder 32. The flap holder 32b can include another safeguard device, illustrated as a flap 53. The flap 53 is part of the holder 32b, in other words it is a cut into the holder on three sides and flaps open therefrom. The flap 53 and aperture 54a overlap such that the flap 53 ends up underneath the aperture 54a when folded to form a variation of the single common aperture 54 described herein.

FIG. 5 illustrates a two-part holder 32c, a variation of the holder 32. The two-part holder 32c can include two parts, an upper portion 37 and a lower portion 39. The upper portion 37 can include a variation of the single common aperture 54 described herein. The lower portion 39 can include the pattern 64 having the at least one opening 66, illustrated as three openings.

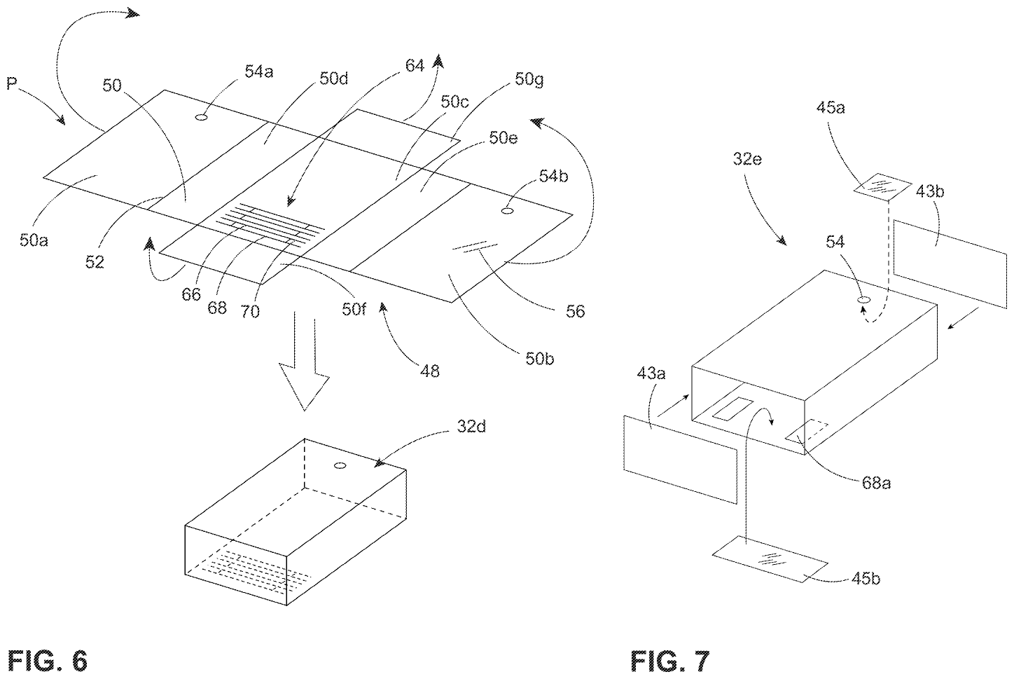

FIG. 6 illustrates an enclosed holder 32d in the form of a six-sided cuboid, a variation of the holder 32. The flat form 48 can include seven portions 50 separated by folding lines 52. Like the holder 32, enclosed holder 32d can include the two end portions 50a, 50b, the third portion 50c, the fourth portion 50d, and the fifth portion 50e. Additionally enclosed holder 32d can include two closure portions 50f, 50g that fold to enclose the holder 32d. As previously described herein, the pouch 34 can be received in one of the open ends 38a, 38b when the pod 12 is assembled. The two closure portions 50f, 50g can then be flipped up to close the open ends 38a, 38b to define the enclosed holder 32d.

FIG. 7 illustrates a variation of the holder 32, a sealed holder 32e in the form of a cuboid with end seals 43a, 43b and filter portions 45a, 45b. As previously described herein, the pouch 34 can be received in one of the open ends 38a, 38b when the pod 12 is assembled. The end seals, 43a, 43b, seal off the open ends 38a, 38b. The filter portion 45a can cover the aperture 54, and the other filter portion 45b can be utilized to close a variation of the elongated perforations 68a described herein. In one exemplary pod 12, together the seals 43a, 43b and filter portions 45a, 45b provide a sealed container for a pod 12 having no pouch 34. In essence the sealed holder 32e can be a filter pouch and holder in one piece.

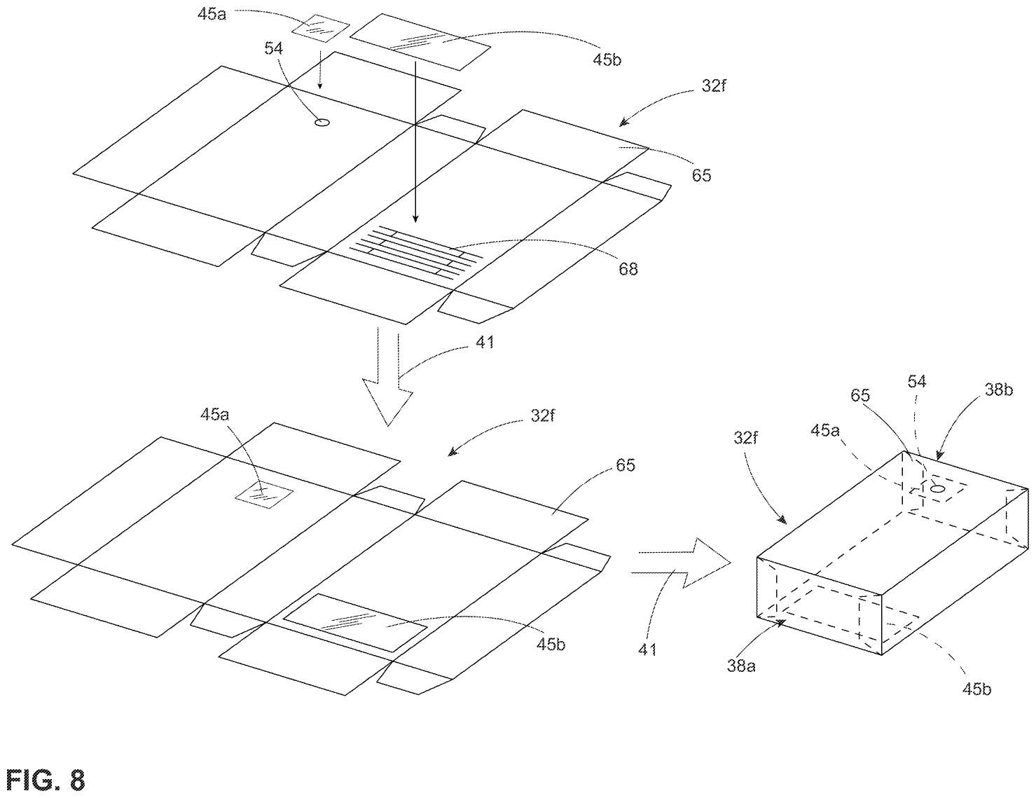

FIG. 8 is another variation of the holder 32, a box holder 32f. The box holder 32f can include the elongated perforations 68 and aperture 54. Filter portion 45a can be provided over the aperture 54 and filter portion 45b can be provided over the elongated perforations 68 prior to folding the box holder 32f as indicated by process arrows 41. The box holder 32f can include tabs 65 such that when folded, form a closed holder similar to enclosed holder 32d. It should be understood that in having the filter portions 45a, 45b, a pouch as described herein would not be necessary.

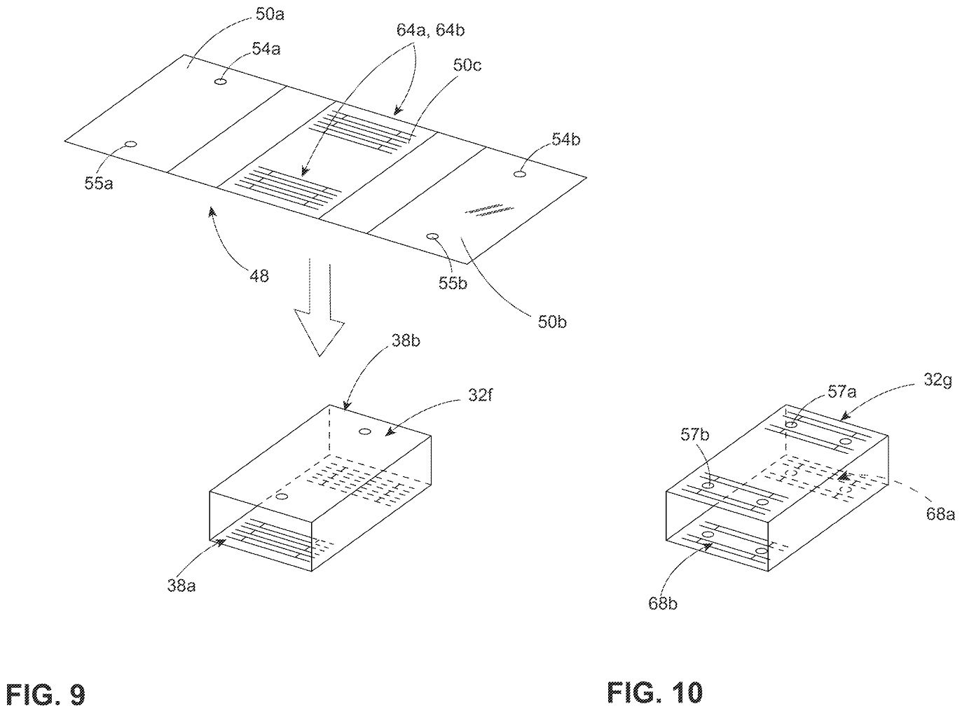

FIG. 9 is yet another variation of the holder 32, a reversible holder 32g. The reversible holder 32g can have two patterns 64a, 64b mirroring each other. Additional to the two sets of apertures 54a, 54b, a set of mirrored apertures 55a, 55b, can be provided in the end portions 50a, 50b respectively. The reversible holder 32g enables the pod 12 to be received from either end 38a, 38b during operation.

FIG. 10 illustrates yet another variation of the holder 32, an omni-directional holder 32h. The omni-directional holder 32h is much like the reversible holder 32g only having multiple sets of apertures, 57b, each set of apertures 57a, 57b straddled by a corresponding set of elongated perforations 68a, 68b. The omni-directional holder 32h enables the pod 12 to be received from either end 38a, 38b during operation and also oriented in either direction such that the pod does not have a distinctive top or bottom.

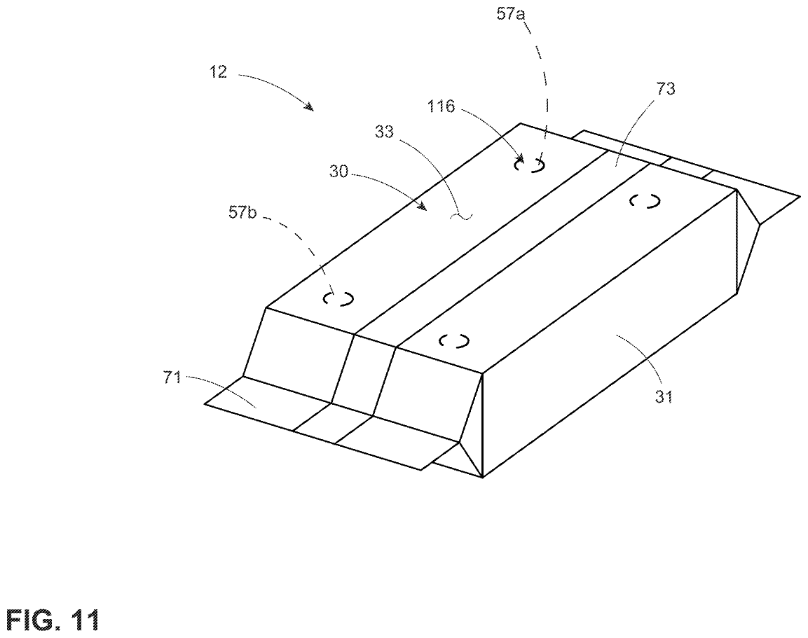

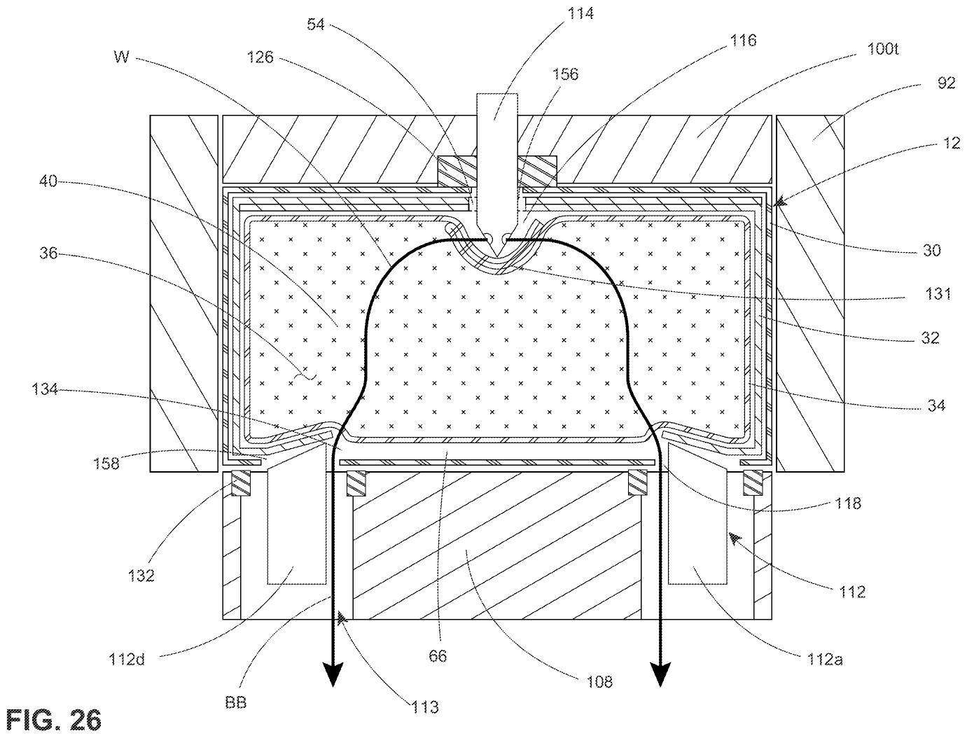

FIG. 11 illustrates the wrapper 30 encasing the omni-directional holder 32g (FIG. 10). The wrapper 30 can include a pair of end seals 71 and a fin seal 73 extending therebetween. It can more clearly be seen that having each set of apertures 57a, 57b (illustrated in dashed line) spaced apart also provides a location for a puncture that avoids the fin seal 73. This is beneficial in that the set of apertures 57a, 57b enable the puncturing of an exterior inlet 156 (FIG. 26), where the set of cutters 112 does not have to puncture through the fin seal 73. The wrapper 30 being a single piece of material that can join to itself to form an enclosure of the pod 12 where the end seal 71 and fin seal 73 are areas of the wrapper 30 joined to form the enclosure.

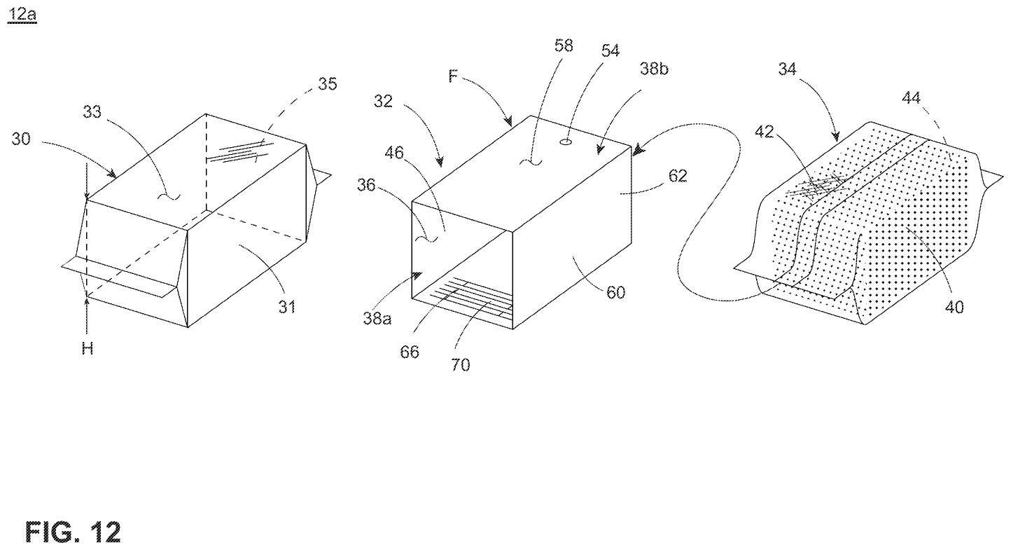

Turning to FIG. 12, it is further contemplated that the pod 12 described herein is can have different sizes. A tall pod 12a, a variation of the pod 12 of FIG. 2, is illustrated. The tall pod 12a can accommodate larger volumes of product, by way of non-limiting example beverage material 40, with a single dimension change. The tall pod 12a has a height (H) that is twice as large as the pod 12 (FIG. 2). The tall pod 12a can be used to make a carafe of coffee rather than a single cup, in one non-limiting example. It should be understood that the tall pod 12a and the pod 12 are alike in all aspects described herein except for the height (H) difference. It should be further understood that any variation of heights is contemplated for different beverage types.

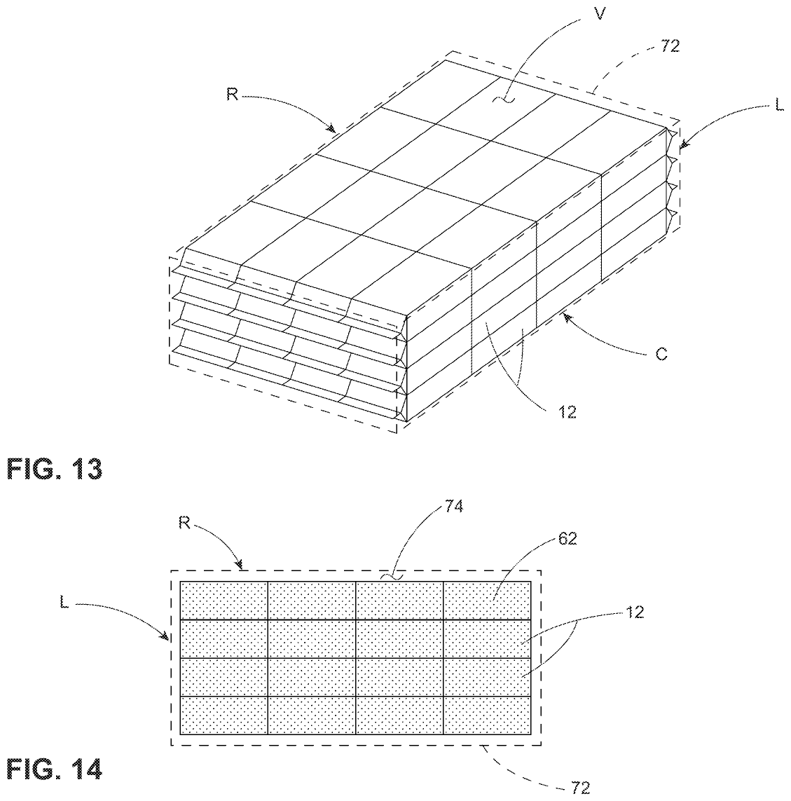

Turning to FIG. 13, an exemplary package 72 can be used for shipping a plurality of pods 12. The exemplary package 72 defines a volume (V) having room for four rows (R), four columns (C), and four layers (L) of pods 12. The exemplary package 72 can therefore hold sixty-four pods 12.

As is shown in FIG. 14, since the shape of the pod 12 is cuboid, the volume (V) of the package 72 is primarily full of the pods 12 and in turn the beverage material 40 with very little wasted space 74. This provides for optimal packaging efficiency by eliminating air space between individual pods 12. It is contemplated that this optimal packaging enables over 80% of the volume (V) to be defined by beverage material 40. It is further contemplated that the optimal packaging enables over 90% of the volume (V) to be defined by beverage material 40.

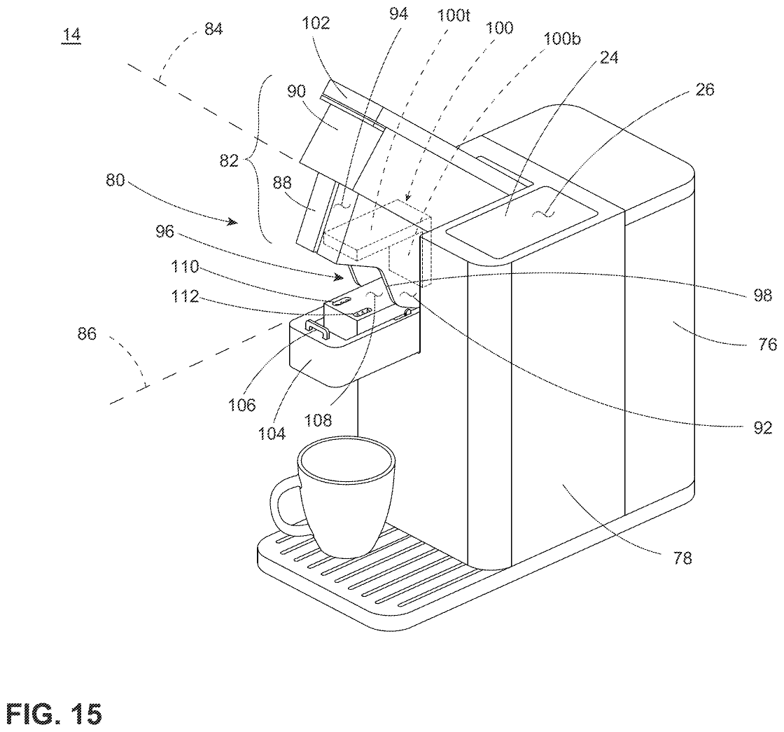

FIG. 15 illustrates the brewer 14. The brewer 14 can include a liquid reservoir 76, a housing 78, and a head 80 coupled to the housing 78. The head 80 can include a closure 82 movable between an open position 84 and a closed position 86 illustrated in dashed lines. The closure 82 can include an inner portion 88 and an outer portion 90, where the inner portion 88 can be nested within the outer portion 90.

The inner portion 88 can include sidewalls 92 and a front wall 94 together defining at least a portion of a chamber 96 in which the pod 12 is received. The chamber 96 is sized to receive a single pod at a time. The pod 12 can be received in the chamber 96 when the closure 82 is in the open position 84. The sidewalls 92 can further include a curved portion 98. The inner portion 88 can further include a top wall 100t and a back wall 100b, illustrated together as a singular L-shaped wall 100. It should be understood that while illustrated as a singular L-shaped wall 100, the top wall 100t and the back wall 100b can be separate walls. The outer portion 90 includes a handle 102 for moving the closure between the open and closed positions 86, 84.

The head 80 can further include a base portion 104 that can have a latch 106 for securing the closure 82 in the closed position 86. The base portion 104 can further include a bottom wall 108 further defining at least a portion of the chamber 96. The curved portion 98 of the sidewalls 92 can be received in the base portion 104. Fully defined, the chamber includes six walls, the sidewalls 92, front wall 94, top wall 100t, back wall 100b, and bottom wall 108. At least one of the six walls has a flat surface, by way of non-limiting example all six walls have a flat surface and together define the chamber 96 for holding the pod 12 in a snug fit.

At least one recess 110 can be located in the bottom wall 108. The at least one recess 110, illustrated as two recesses, can house a set of cutters 112. The set of cutters 112 can be multiple cutters. While illustrated as six cutters, three disposed in each of the two recesses 110, the set of cutters 112 can be any number of cutters including only one. The set of cutters 112 can be in any form suitable for puncturing the pod 12, and more specifically the wrapper 30. The set of cutters 112 can be blades or needles and be formed of any material metal or plastic.

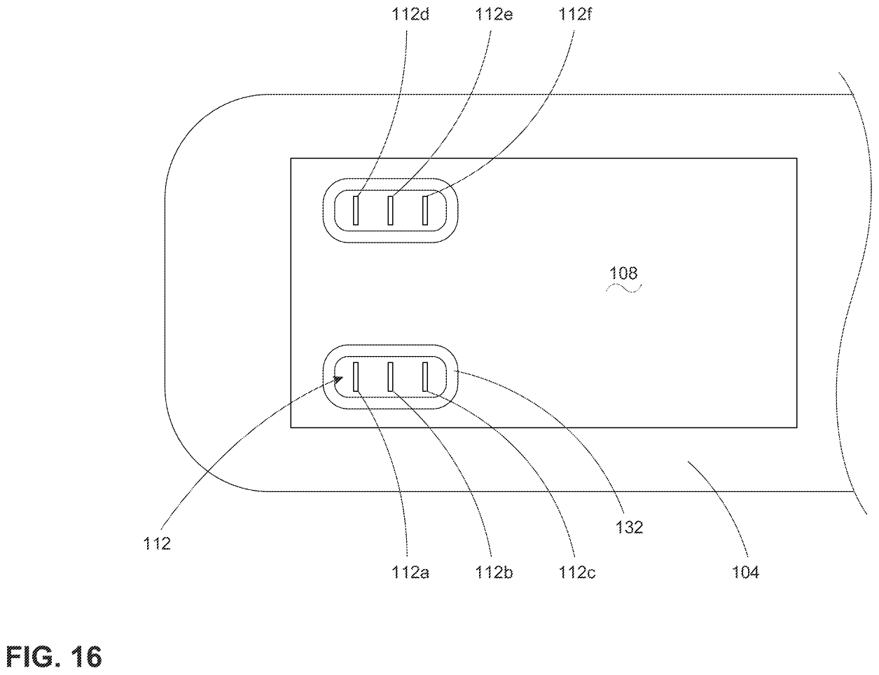

FIG. 16 illustrates a top down view of the bottom wall 108 in the base portion 104 from FIG. 15. The set of cutters 112 are more clearly illustrated. An outlet seal 132 can surround the set of cutters 112 to create an airtight chamber 96 (FIG. 15) when in the closed position 86 (FIG. 18). The set of cutters 112 can have a changeable configuration such that each cutter 112a, 112b, 112c, 112d, 112e, 112f, can be movable in sync or individually. In this manner, the brewer 14 can have a selectable cutting pattern allowing any number of exterior outlets 158 (FIG. 26) to be punctured into the wrapper 30 to control pressure within the pod 12. Less exterior outlets 158 create a higher pressure in the pod 12. The total area of cuts can vary depending on operating requirements. An increased total area of cuts decreases the internal pod pressure because there is more area for water to escape.

It is further contemplated that the set of cutters 112 are a stationary set of cutters. During operation, water injected into the pod can create internal pressure causing the wrapper 30 to expand and press into the stationary set of cutters 112, puncturing the wrapper 30.

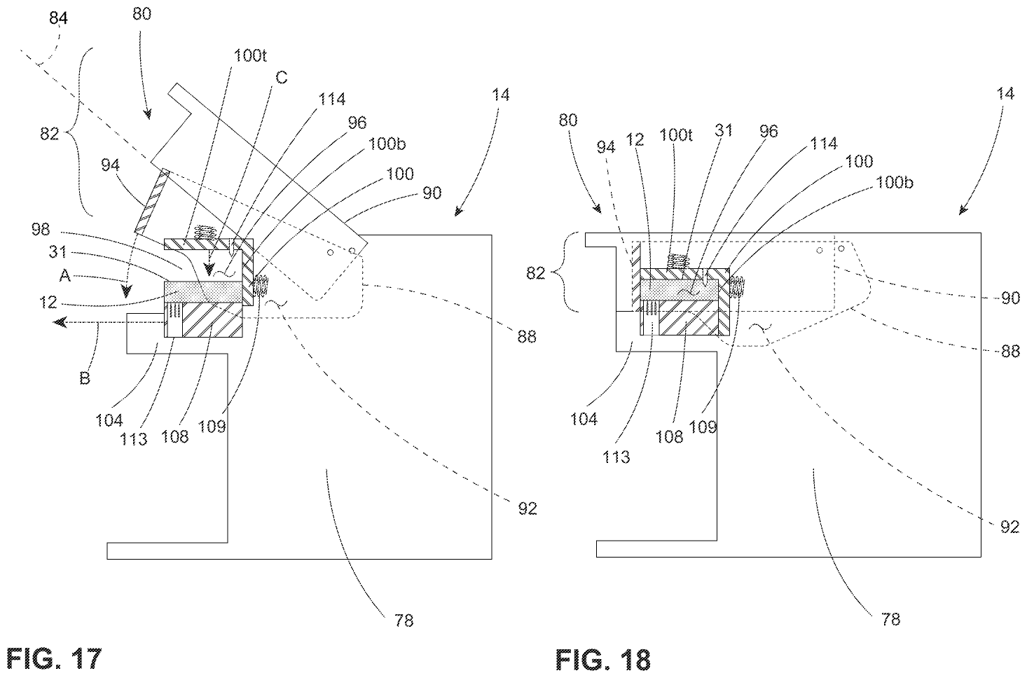

Turning to FIG. 17 an exemplary schematic side view of the brewer 14 with the closure 82 in the open position 84 is illustrated. The walls 92, 94, 100t, 100b, 108 and base portion 104 are illustrated in cross-section to clearly show an inlet needle 114 and a brewer outlet 113. A side portion of the housing 78 has been removed to illustrate the inner and outer portions 88, 90. At least one of the side walls 92, the front wall 94, the top wall 100t, the back wall 100b, and the bottom wall 108 is a movable wall capable of compressing against the pod 12 when the closure 82 is moved into the closed position 86. In one non-limiting example a biasing mechanism 109, for example a spring, can be utilized to move the movable wall. The biasing mechanism 109 can be located in any suitable arrangement, including in contact with the top wall 100t or the back wall 100b as illustrated. It is contemplated that at least two or four of the walls 92, 94, 100t, 100b, 108 are movable walls. It is further contemplated that all of the walls 92, 94, 100t, 100b, 108 are movable walls.

In the exemplary schematic view a sequence occurs when moving the closure 82 from the open position 84 to the closed position 86. As the closure 82 is moved to the closed position 86, the inner portion 88 is pushed downward at arrow (A) by the outer portion 90. Furthermore, as the closure 82 is moved to the closed position 86, bottom wall 108, top wall 100t and back wall 100b are pushed forward at arrow B. In one non-limiting example the biasing mechanism 109, can be utilized to exert the push on back wall 100b. Furthermore, as the closure 82 is moved to the closed position 86, top wall 100t is pushed downward at arrow C. As top wall 100t is pushed downward the inlet needle 114 punctures the pod 12. Furthermore, as the closure 82 is moved to the closed position 86, at least one of the set of cutters 112 is pushed up to puncture pod 12.

Turning to FIG. 18, in the closed position 86 the side walls 92, the front wall 94, the top wall 100t, the back wall 100b, and the bottom wall 108 can provide support to their corresponding pod walls 31. Further all of the walls 92, 94, 100t, 100b, 108 together define the chamber 96 when in the closed position. The walls 92, 94, 100t, 100b, 108 can withstand pressure in the chamber 96 produced during a brewing operation. It should be understood that each of the six walls of the chamber 96 can counteract a bursting pressure built up from the pod 12 during operation. With six walls all having a flat surface, the chamber 96 can have a cuboid shape for holding the pod 12 in a snug fit.

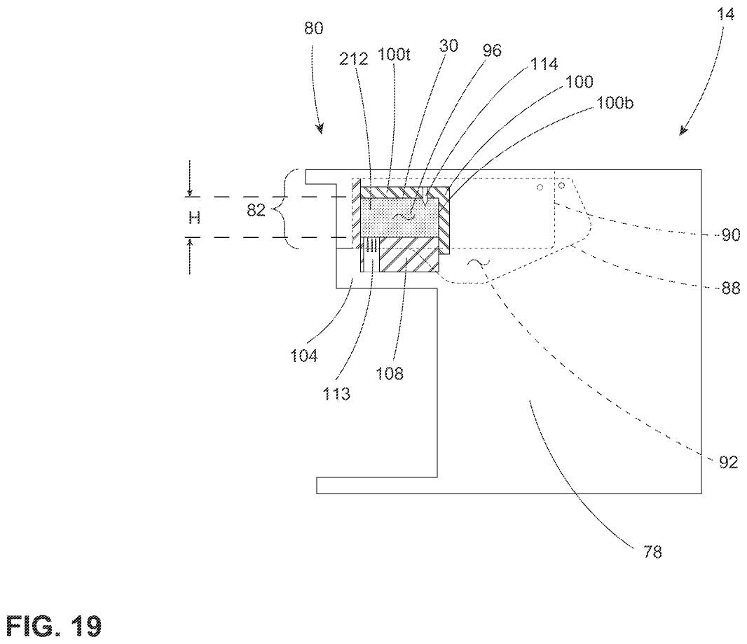

FIG. 19 illustrates closure 82 again in the closed position 86. In this figure, however, the tall pod 12a, is shown in place. It should be understood that the same sequence occurs, however during the downward motion of (C) the top and back walls 110t, 110b translate less of a downward distance. In this manner, the brewer 14, as described herein can accommodate pods 12, 12s of altering volumes, in particular pods 12, 12a that vary in a single vertical dimension, or height.

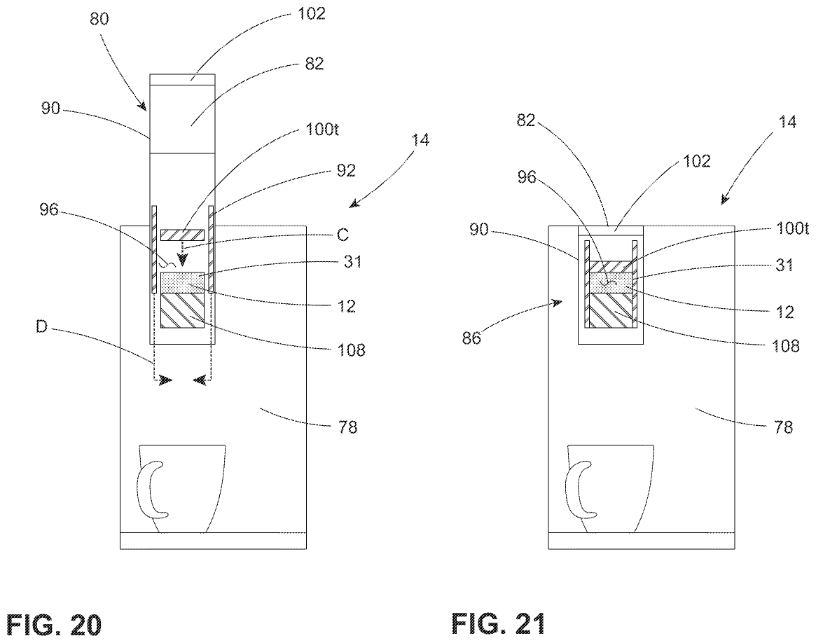

FIG. 20 is an exemplary schematic front view of the brewer 14 with the closure 82 in the open position 84. During the sequence described in FIG. 6A as the closure 82 is moved downward, the top wall 100t is moved downward at arrow (C), while simultaneously the sidewalls 92 are pushed toward each other. The outer portion 90 of the closure 82 causes the sidewalls 92 of the inner portion 88 to squeeze together at arrows (D).

Turning to FIG. 21, in the closed position 86, it can more clearly be seen that the bottom wall 108, the top wall 100t, and the sidewalls 92 can provide support to their corresponding pod walls 31.

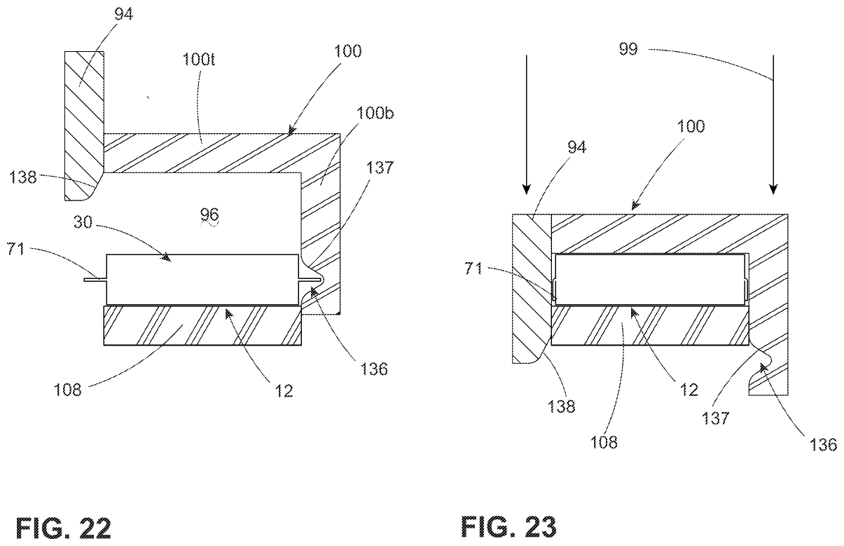

FIG. 22 is a schematic side cross-sectional view of a variation of the chamber 96 according to an aspect of the disclosure herein. The singular L-shaped wall 100 can include a recess 136 along the back wall 100b. The recess 136 can define a first ramped portion 137. Further, the front wall 94 can include a second ramped portion 138 facing the chamber 96. When in place, the end seals 71 of the pod 12 can be received in the recess 136.

Turning to FIG. 23, in the closed position 86, it can more clearly be seen that the when the singular L-shaped wall 100 and the front wall 94 can translate down (arrow 99) independently of each other closing the pod 12 within the chamber 96 to fill the chamber 96. The movement of the front wall 94 causes contact between the second ramped portion 138 and the end seal 71 on one side of the pod 12. Similarly, the movement of the singular L-shaped wall 100 forces the end seal 71 on the opposing side of the pod 12 to slide out of the recess 136. In the full closed position 86, the end seals 71 flap down onto the pod walls 31 defining the cuboid shape of the pod 12.

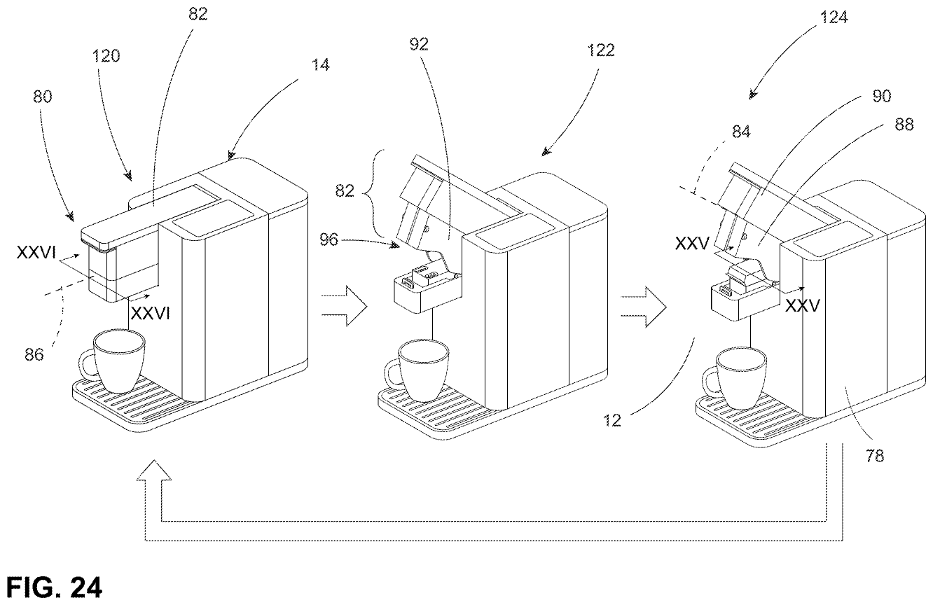

FIG. 24 illustrates the brewer 14 in multiple positions. Some numerals have been removed for clarity. First, the brewer 14 is in a ready position 120 associated with the closed position 86 of the closure 82. It should be understood that the ready position 120 can be associated with the brewer 14 in an operating or in a non-operating state. Secondly, the brewer 14 is illustrated in a receiving position 122 associated with the open position 84 of the closure 82. It can be seen that the brewer 14 is capable of receiving the pod 12 in the chamber 96. Finally, the brewer is illustrated in a prepped position 124, also associated with the open position 84 of the closure 82 and where the pod 12 has been inserted in place. Upon moving the closure 82 from its open position 84 to its closed position 86, the brewer transitions back to the ready position 120 and can begin operating.

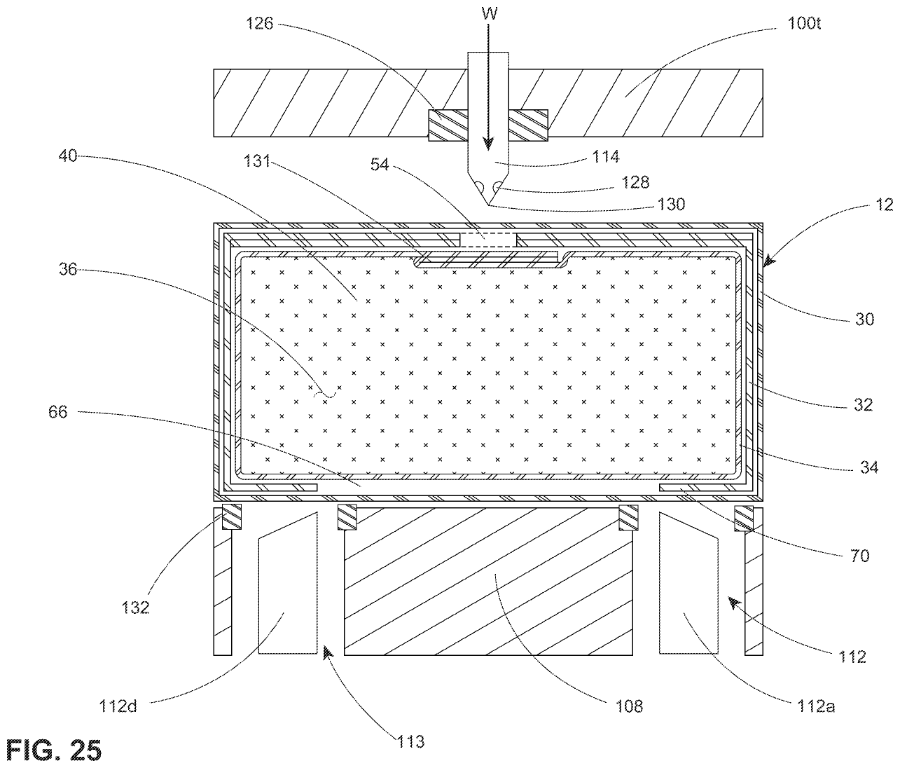

Turning to FIG. 25, an enlarged cross-sectional view along line XXV-XXV of FIG. 24 of the pod 12 and base portion 104 is illustrated. The inlet needle 114 can extend from the closure 82, more specifically from the top wall 100t. A seal 126 is formed within the top wall 100t. The seal 126 prevents water from leaking to the outside of the pod 12 around needle 114 during the brewing operation. The inlet needle 114 is in line with the aperture 54, illustrated in dashed line, of the holder 32. The holder 32 enables a correct puncturing of the wrapper 30. The holder 32 supports the wrapper 30 and prevents any deflection away from the inlet needle 114. This ensures proper passage of water (W) via the inlet needle 114, and specifically via water openings 128 proximate a tip 130 of the inlet needle 114, to inside the pod 12. A pouch seal 131 can be oriented to align with the inlet needle 114 to form an area with greater strength such that the inlet needle 114 is prevented from puncturing the pouch 34.

The holder 32 further prevents any deflection of wrapper 30 away from the set of cutters 112, allowing the set of cutters 112 to puncture the wrapper 30 when the brewer 14 is in the ready position 120. The support of the holder 32 can prevent the wrapper 30 from deflecting away from the inlet needle 114 and/or the set of cutters 112. Deflection of wrapper 30 by the inlet needle 114 or cutters 112 could cause the wrapper 30 to remain sealed and not punctured, which is undesirable. The holder 32, therefore, acts as an internal structural piece of the pod 12 to enable both piercing by the inlet needle 114 and the set of cutters 112.

Turning to FIG. 26, an enlarged cross-sectional view along line XXVI-XXVI of FIG. 24 of the pod 12 and base portion 104 is illustrated when the brewer 14 is in the ready position 120. The inlet needle 114 is illustrated as having punctured the wrapper 30 to form the exterior inlet 156. The exterior inlet 156 aligns with the aperture 54 to define a fluid inlet 116. The inlet needle 114 is received in the aperture 54 of the holder 32. The inlet needle 114 does not puncture the pouch 34. The inlet needle 114 is therefore protected from beverage material 40 within the pouch 34 to prevent any clogging of the water opening 128.

Simultaneously, the set of cutters 112 can puncture the wrapper 30 and move into the at least one opening 66 during the brewing operation to fully define the fluid outlet 118. The tabs 70 formed in the holder 32 by the elongated perforations 68 can prevent the set of cutters 112 from puncturing the pouch 34. The set of cutters 112 can deflect the tabs 70 toward the interior 36 of the pod 12. The set of cutters 112 remain in the pod 12 during the brewing process to ensure passage of water (W) through the fluid outlet 118. The tabs 70 can then be enabled to push the pouch 34 away from the wrapper 30, creating an air gap 134 that enables passage of water (W) from the water opening 128 through the beverage material 40 and out of the chamber 96. It is contemplated that the tabs 70 enable an air space large enough through which the brewed beverage can pass in which case the at least one opening 66 is not necessary. The pouch 34 as described herein benefits from the air gap 134 in that the pouch 34 is not pressed against something else without an outlet. The air gap 134 enables the fluid outlet 118 to function properly on another side of the pouch 34 to enhance the performance of the brewer 14. A brewed beverage (BB) exits the pod outlet after traveling through the pouch 34. It should be understood that the brewed beverage (BB) can be any suitable beverage including brewed coffee.

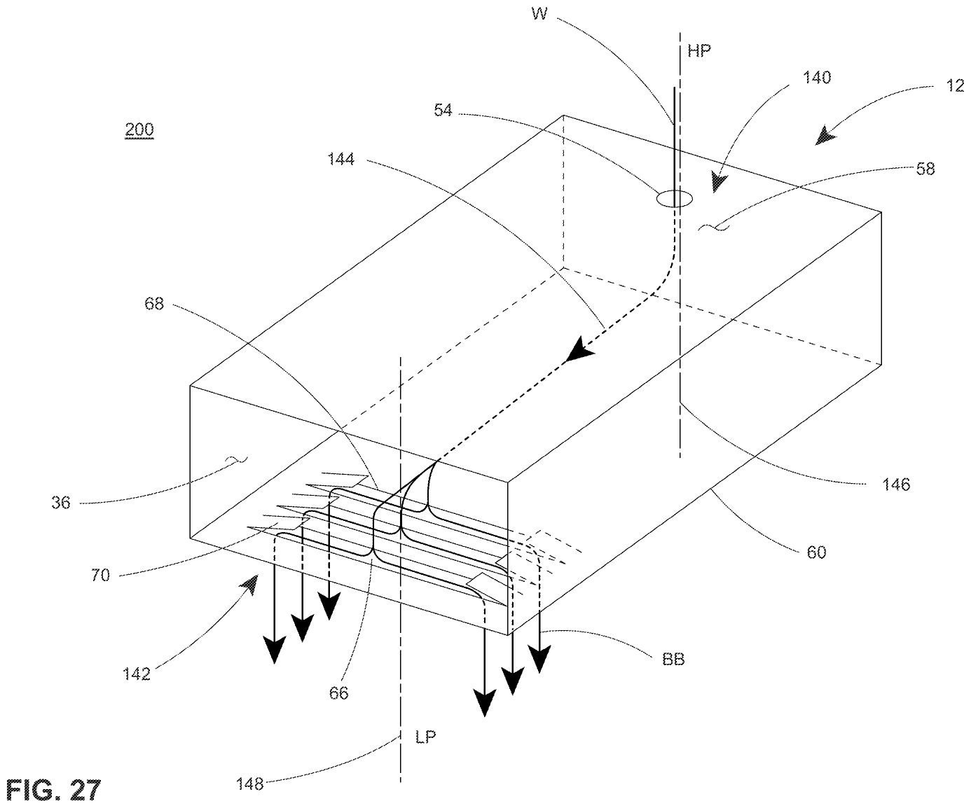

FIG. 27 illustrates a method 200 of passing the water (W) through a packaged substance, by way of non-limiting example the pod 12 as described herein. The wrapper 30 and pouch 34 of the pod 12 have been removed for clarity leaving the holder 32 to aid in a visualization of the method 200. A pressure differentiation can be formed during operation between the fluid inlet 116, illustrated as a relatively high-pressure area HP, and the fluid outlet 118, provided by the through openings 66, illustrated as a low-pressure area LP. Water is introduced to the aperture 54 from the high-pressure area HP. Water (W) is then forced to move through an entirety of the pod 12 before exiting the pod 12 through the openings 66 formed by the elongated perforations 68 toward the low-pressure area LP. By forming the aperture 54 at a first end 140 of the holder 32 and the elongated perforations 68 at a second end 142 opposite the first end 140 and located on the bottom 60 of the holder 32, the water comes in the first end 140 along the top 58 through aperture 54 and leaves through the second end 142 along the bottom through openings 66. This forces the water along a flow path 144 within the pod 12 in a uniform manner. Vortices of swirling water or pools of saturated grounds and unsaturated grounds are therefore prevented. The water (W) is forced to travel along the flow path 144 that is longer than it is wide enabling the beverage material 40 in the sealed pouch 34 to maintain their shape throughout the brewing process. The water (W) can be injected through aperture 54 along an axis 146 that is perpendicular to the flow path 144 inside the pod 12 and the brewed water (BW) can exit perpendicular to the flow path 144 inside the pod, or along a parallel axis 148 to the axis 146 along which it entered.

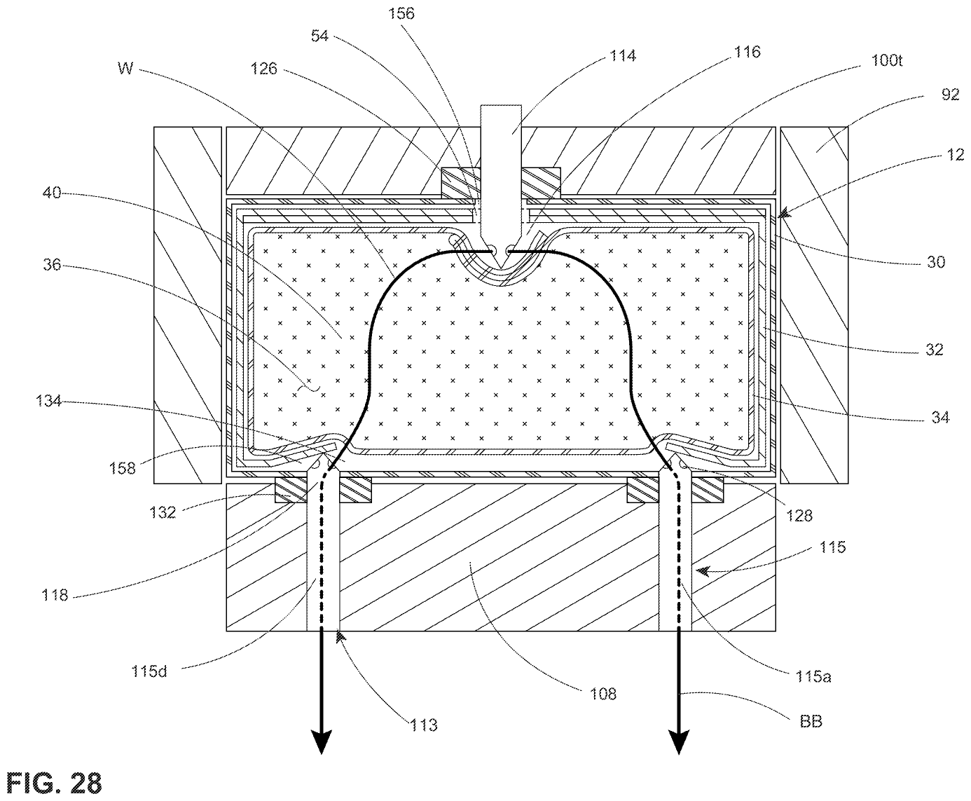

FIG. 28 is a variation of the enlarged cross-sectional view of FIG. 10 of the pod 12 and base portion 104. The set of cutters 112 as described herein can be formed instead as a set of needles 115. In other words, the inlet needle 114 and the set of needles 115 can be the same type of mechanism. The set of needles 115 can include water openings 128 that define at least a portion of the fluid outlet 118 to ensure proper passage of the brewed beverage (BB) through the brewer outlet 113.

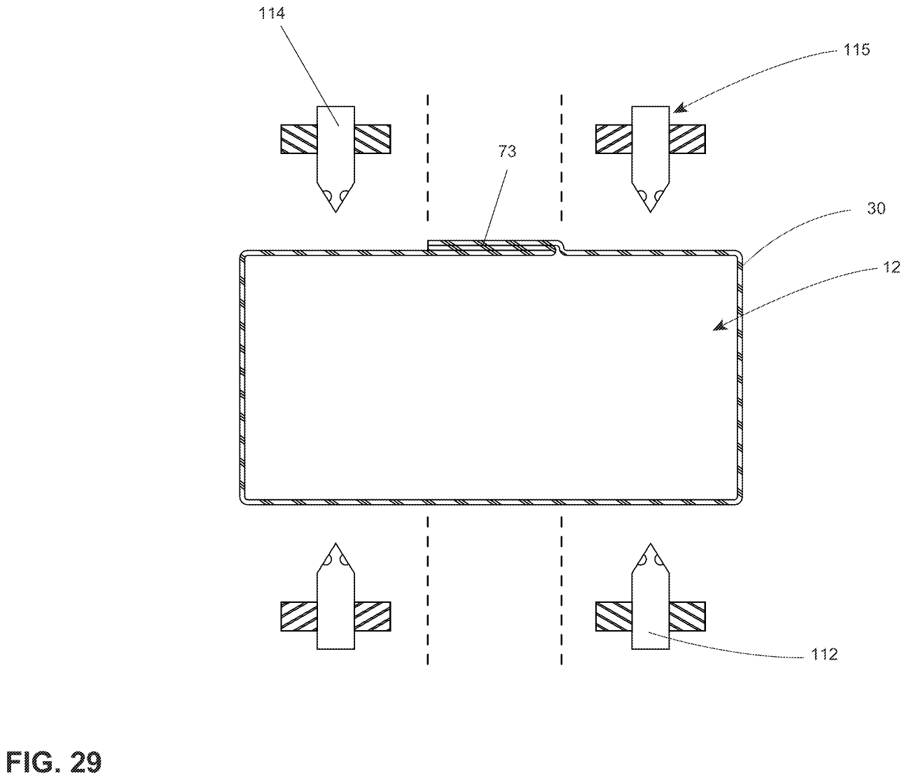

FIG. 29 is a schematic of the set of needles 115 including at least one inlet needle 114 and the set of cutters 112. The wrapper 30 is illustrated in cross-section with the fin seal 73 facing the at least one inlet needle 114. The pod 12 is illustrated with all other parts removed save for the wrapper 30 for clarity. The set of needles 115 are spaced to straddle the fin seal 73. It can more clearly be seen that spaced apart inlet needles 114 are beneficial in order to enable puncturing in locations with a single layer of film rather than the multiple layers at the fin seal 73. Additionally, avoiding the fin seal 73 is beneficial for the life of the inlet needles 114 and for maintaining rigidity of the pod 12. It should be understood that the set of cutters 112 and/or the set of needles described herein can include any combination of needles and cutters described herein.

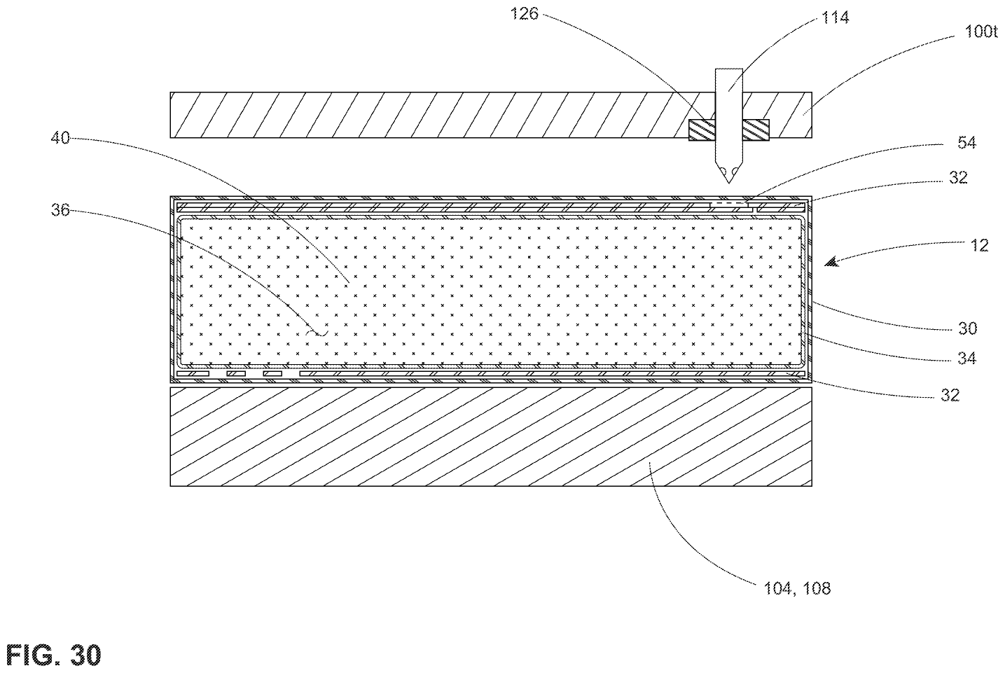

FIG. 30 is a cross section along the longitudinal axis A-A illustrating a variation of the pod 12 with the flap holder 32b (FIG. 4) and the base portion 104. The flap holder 32b, and more specifically the flap 53, can provide protection during operation of the pouch 34. The flap 53 is part of the holder 32b, in other words it is a cut into the holder on three sides and flaps open therefrom.

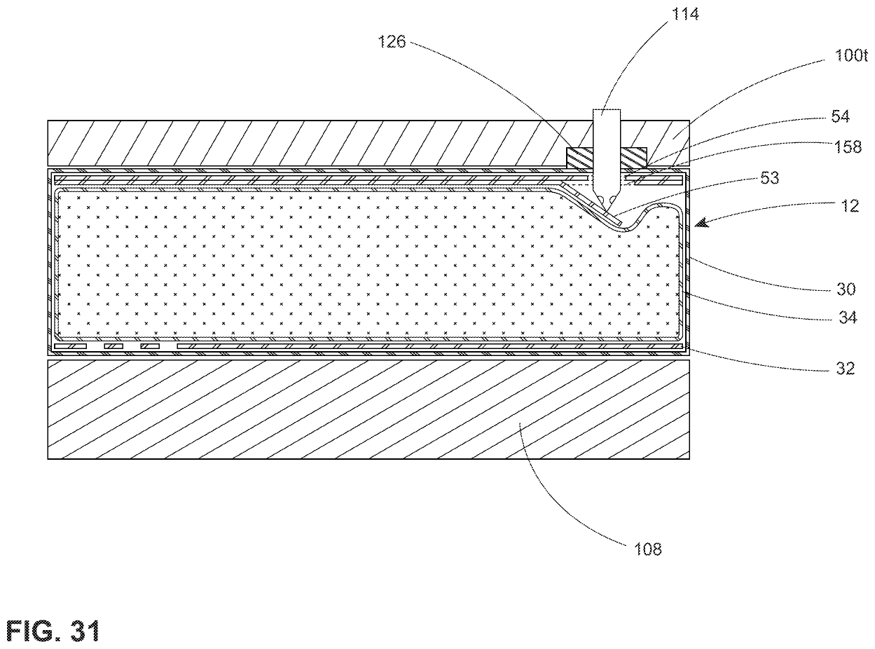

Turning to FIG. 31, the flap holder 32b from FIG. 28 is illustrated in the ready position 120. It can more clearly be seen that the pouch 34 can remain intact and free from any punctures when the pod 12 includes the flap holder 32b having a flap 53. It should be understood that while flap holder 32b is referenced, any variation of the any of the holders having the flap as described herein is contemplated.

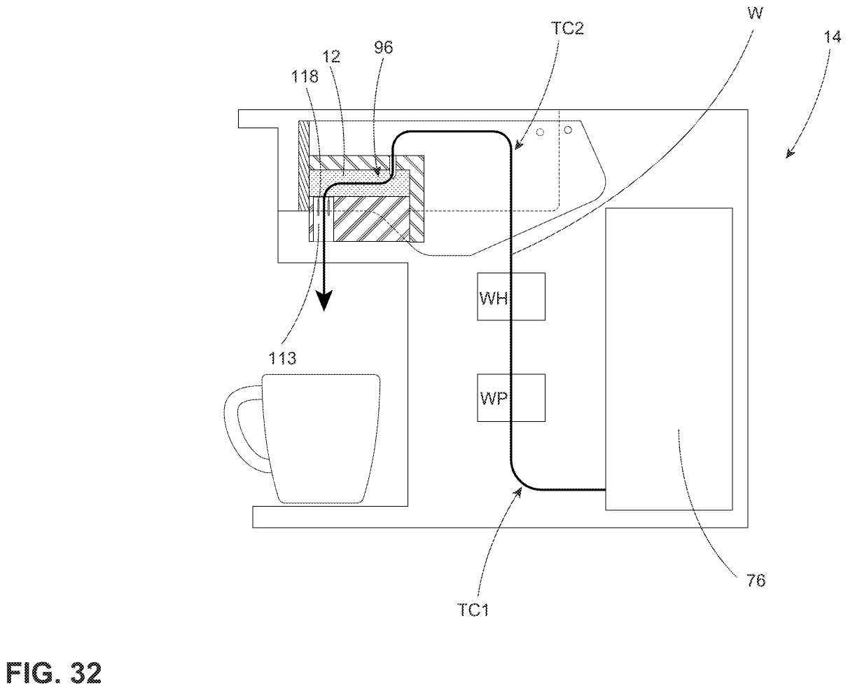

FIG. 32 illustrates one possible path the water (W) can travel from the liquid reservoir 76 to the brewer outlet 113. The water (W) can undergo a first temperature check (TC1) upon exiting the liquid reservoir 76. The water (W) can then be pumped up to the chamber 96 by a water pump (WP). Prior to entering the chamber 96 and in turn the pod 12, the water (W) can be heated by a water heater (WH). A second temperature check (TC2) can occur prior to entering the chamber and after being heated by the water heater (WH). The combination of temperature checks enables a controlled temperature of the water (W) along with a control of an amount of heating by the water heater (WH).

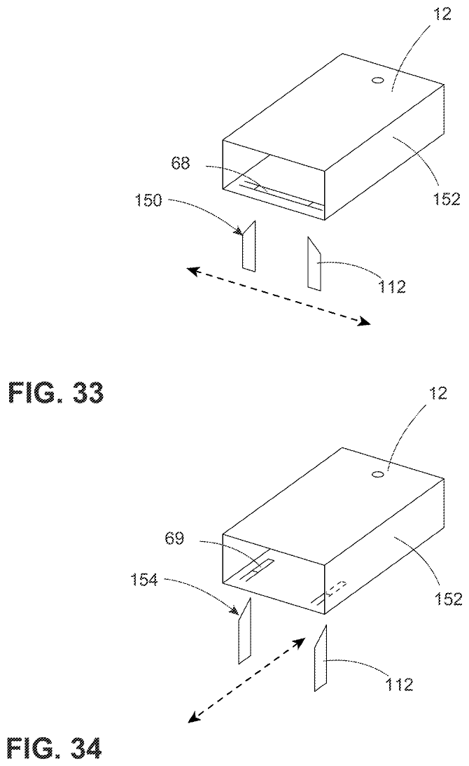

FIG. 33 illustrates a first orientation 150 for the set of cutters 112 described herein. In the first orientation the set of cutters 112 can cut in a direction perpendicular to a long side 152 of the pod 12, or the flow path 144 as described herein.

FIG. 34 illustrates a second 154 orientation for the set of cutters 112 described herein. In the second orientation 154 the set of cutters 112 can cut in a direction parallel to the long side 152 of the pod 12, or the flow path 144 as described herein. It should further be noted that the elongated perforations 68 as described herein can be oriented in the second orientation 154 to define a second set of elongated perforations 69.

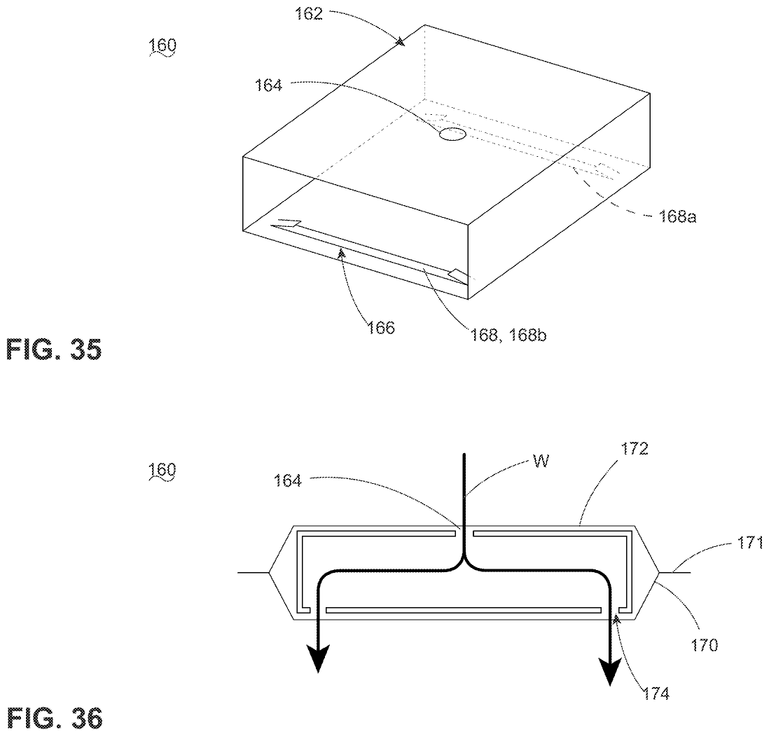

In yet another aspect of the disclosure herein a variation of the pod 12 described herein is illustrated in FIG. 35 as a centralized pod 160. Some numerical indicators have been removed for clarity. It should be understood that the parts associated with the pod 12 previously described are attributed to the centralized pod 160 unless otherwise noted. A wrapper and pouch of the centralized pod 160 have been removed for clarity leaving a centralized holder 162. In this exemplary variation, the centralized holder 162 includes an aperture 164 centered with respect to the centralized pod 160. A pattern 166 having at least one opening 168, illustrated as two single openings 168a, 168b can be located in the centralized holder 162 proximate opposing ends 170 of the centralized pod 160. While illustrated as a square, the centralized pod 160 can be any shape including the rectangular shape previously described herein. The central location of the aperture 164 can be beneficial for brewing specialized beverages such as espresso.

FIG. 36 illustrates the centralized pod 160 with a wrapper 172 and the centralized holder 162. It can more clearly be seen that water (W) can enter the centralized pod 160 forming a high-pressure area HP beneficial to brewing specialized beverages like espresso. In operation, the openings 168a, 168b are open to the atmosphere to define a holder outlet 174 and therefore create a low-pressure area LP. End seals 171 are provided on the centralized pod 160 at the ends 170 proximate the low-pressure area LP.

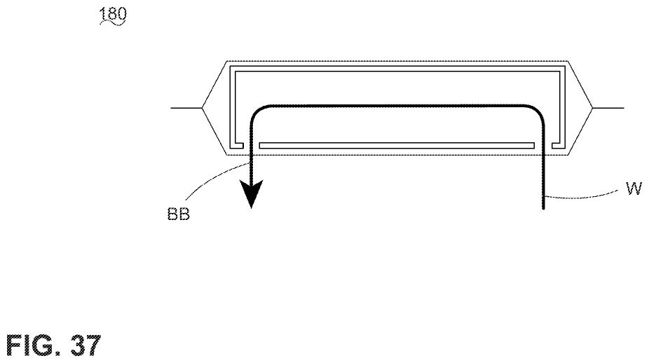

In yet another aspect of the disclosure herein an exemplary pod 180 is illustrated in FIG. 37. It is contemplated that the water (W) can enter via the inlet needle on a same side as the brewed beverage (BB) leaves the pod. The numerical indicators have been removed for clarity. It should be understood that the parts associated with all variations of the pods previously described can be attributed to the illustrated exemplary pod 180 of FIG. 37.

Benefits associated with the disclosure herein include that the wrapper is not mechanically attached to any other component. This means sealing and containment of the internal components (coffee grounds, pouch, structural pieces, water/brewed coffee) does not require an assembly of multiple components. This allows for manufacturing benefits with regards to making parts and changing parts during assembly. By splitting the pod into multiple parts, each having its own function, the material choices for the pod as described herein vary depending on the part being manufactured. This enables a greater selection of materials to be used since there does not need to be consideration about the compatibility of each material for joining during manufacturing. This allows for much more flexibility in material choices and the ability to use ones that are more sustainable. By contrast, known pods include a single part that serves two functions: a barrier to preserve freshness and a structure to maintain shape. Requiring a multi-function single part unnecessarily narrows down options for materials. Conversely, the pod described herein is rigid with separate barrier component and structural components. This allows for more choice in terms of a material selection—including ones more sustainable materials.

Further, a single wrapper differs from other known pods as well. Pods in the brewing industry typically have a barrier that is comprised of multiple pieces. For example, a K-Cup® relies on a film top joined to a plastic cup. The wrapper disclosed herein enables a selection of a material with barrier properties independently without affecting any other components. Other known pods cannot simply change to using biodegradable plastics because their current structure would not enable high enough barrier properties required to keep grounds fresh and contained.

The rigid structure, holder as described herein, is completely enclosed within the wrapper, or barrier component. This means the structural component does not need to have any barrier properties. Currently, existing pods require a barrier component to protect the coffee grounds from air, light and moisture and maintain its freshness. Exposure to these elements can cause the coffee grounds to degrade. In existing pods, exterior components provide the barrier properties utilizing plastics and/or metals. A greater flexibility for material choice is enabled, because the rigid structure described herein does not need barrier properties. Therefore, eco-friendly materials such as paperboard can be used. In fact, the entire pod described herein, can be eco-friendly, the pods, including the wrapper, holder, and the pouch, can be made from plant-based materials and are biodegradable or compostable after use and the packaging allows for more product to be shipped with less waste.

Furthermore, because the structural component of the pod is completely sealed within the pod, it does not need to withstand high pressures associated with the brewing process. The high pressures inside the pod during operation can be transferred through the flexible wrapper into the rigid walls of brewing chamber of the brewer.

Additionally, control of the pressure and water temperature in the brewer as described herein enable coffee that is brewed to an ideal balance. The shape of the pod forces the water inside to flow in a uniform column ensuring even saturation of the coffee grounds by eliminating vortices or localized channels.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various characteristics, aspects, and advantages of the present disclosure may also be embodied in the following solutions as defined by the clauses:

A beverage system comprising a brewer, the brewer having a chamber defined by a set of walls including a pair of sidewalls each comprising a flat surface; and a closure movable between an open position allowing access to the chamber and a closed position closing access to the chamber.

The beverage system of any preceding clause, further comprising a base portion with a flat surface defining a bottom wall of the chamber, wherein the bottom wall is part of the set of walls.

The beverage system of any preceding clause wherein the bottom wall further comprises a recess housing a set of cutters movable from within the recess to at least partially outside of the recess into the chamber.

The beverage system of any preceding clause wherein the pair of sidewalls are parallel to each other and perpendicular to the bottom wall.

The beverage system of any preceding clause wherein the set of walls further includes a top wall, a front wall, and a back wall defining a remaining portion of the chamber.

The beverage system of any preceding clause wherein at least one of the top wall, the front wall, and the back wall comprise a flat surface.

The beverage system of any preceding clause wherein the set of walls includes at least three walls that independently movable with respect to each other.

The beverage system of any preceding clause wherein the at least three walls are a top wall, a front wall, and a back wall.

The beverage system of any preceding clause wherein the set of walls includes at least one movable wall defined by the closure.

The beverage system of any preceding clause wherein the chamber is configured to receive pods of different sizes that differ with respect to each other by a single dimension.

The beverage system of any preceding clause wherein the at least one movable wall translates along one direction to accommodate the pods of different sizes.

The beverage system of any preceding clause wherein the brewer is configured to receive at least one pod that fits snug within the chamber when the closure is in the closed position.

The beverage system any preceding clause wherein the chamber has an extruded shape defined by the set of walls when in the closed position.

The beverage system of any preceding clause wherein the extruded shape is a cuboid shape.

A beverage system comprising at least one pod of beverage material, the at least one pod comprising: a holder, a wrapper fully enclosing the holder, the wrapper defining an exterior of the at least one pod, wherein the exterior of the at least one pod is configured to be punctured to form an exterior inlet and an exterior outlet.

The beverage system of any preceding clause wherein the holder has an extruded shape.

The beverage system of any preceding clause wherein the holder comprises at least two flat sides parallel to each other.

The beverage system of any preceding clause wherein the extruded shape is a cuboid shape.

The beverage system of any preceding clause wherein the holder defines a rigid structure of the pod.

The beverage system of any preceding clause wherein the holder includes at least one opening having at least a portion aligning with the exterior outlet to define a fluid outlet.

The beverage system of any preceding clause wherein the holder includes at least one aperture having at least a portion aligning with the exterior inlet to define a fluid inlet.

The beverage system of any preceding clause further comprising a filter portion within the holder wherein the holder comprises at least one safeguard device to protect the filter portion when the exterior is punctured.

The beverage system of any preceding clause further comprising at least one opening in the holder that aligns with at least one of the exterior inlet or the exterior outlet and wherein the filter portion covers the at least one opening to seal the holder for holding the beverage material.

The beverage system of any preceding clause wherein the filter portion is a filter pouch separated from and located within the holder, the filter pouch holding the beverage material.

The beverage system of any preceding clause wherein the wrapper is a single piece of material that is unattached to the holder.

The beverage system of any preceding clause wherein the wrapper is snug fit around the holder.

A beverage system comprising at least one pod with a holder and a wrapper fully enclosing the holder, the wrapper defining an exterior of the at least one pod; and a brewer having a chamber defined by a set of walls including a pair of sidewalls each comprising a flat surface; and a closure movable between an open position allowing access to the chamber and a closed position closing access to the chamber; wherein the brewer is configured to puncture the exterior of the at least one pod when the closure is moved from the opened position to the closed position to form an exterior inlet and an exterior outlet in the exterior of the at least one pod.

The beverage system of any preceding clause wherein the holder has an extruded shape.

The beverage system of any preceding clause wherein the at least one pod further comprises a set of end seals and wherein the set of walls comprise at least one ramped portion configured to press against the set of end seals to form a snug fit within the chamber.

The beverage system of any preceding clause wherein the at least one pod has a cuboid shape.

The beverage system of any preceding clause wherein the chamber further comprises a recess housing a set of cutters.

The beverage system of any preceding clause wherein the set of cutters is located in a bottom wall of the chamber and has a changeable configuration for varying a number of exterior outlets pierced into the pod.

The beverage system of any preceding clause wherein the set of cutters is a set of stationary cutters configured to puncture the wrapper as the wrapper expands to define the exterior outlet.

The beverage system of any preceding clause wherein the holder comprises a pattern of openings for controlling an internal pressure of the pod.

The beverage system of any preceding clause wherein the holder comprises a pattern of openings for controlling a flow of liquid within the holder.

A method for brewing a beverage, the method comprising passing water through a packaged substance defining an interior, passing the water from an area of relatively high pressure to an area of relatively low pressure with respect to the interior, introducing the water in a first direction, forcing the water through the interior in a second direction different than the first direction, dispensing the water from the interior.

The method of any preceding clause, further comprising introducing the water through an aperture at a first end of the packaged substance and dispensing the water through a second end opposite the first end.

The method of any preceding clause, wherein forcing the water through the interior further comprises flowing the water along a flow path at a uniform rate.

The method of any preceding clause, wherein forcing the water through the interior further comprises flowing the water along a flow path that is longer than it is wide.

The method of any preceding clause, wherein dispensing the water from the interior further comprises dispensing brewed water from the packaged substance.

The method of any preceding clause wherein dispensing the water from the interior comprises dispensing the water in the first direction.

The method of any preceding clause wherein the second direction is perpendicular to the first direction.

The method of any preceding clause further comprising controlling a flow of water through the packaged substance.

The method of any preceding clause wherein controlling the flow of water includes directing the water to an exterior outlet of the packaged substance.

The method of any preceding clause wherein controlling the flow of water includes increasing or decreasing an amount of the flow of water.

What is claimed is:

1. A beverage system comprising a brewer, the brewer having a chamber defined by a set of walls including a pair of sidewalls each comprising a flat surface; and a closure movable between an open position allowing access to the chamber and a closed position closing access to the chamber.

2. The beverage system of claim 1, further comprising a base portion with a flat surface defining a bottom wall of the chamber, wherein the bottom wall is part of the set of walls.

3. The beverage system of claim 2 wherein the bottom wall further comprises a recess housing a set of cutters movable from within the recess to at least partially outside of the recess into the chamber.

4. The beverage system of claim 2 wherein the pair of sidewalls are parallel to each other and perpendicular to the bottom wall.

5. The beverage system of claim 2 wherein the set of walls further includes a top wall, a front wall, and a back wall defining a remaining portion of the chamber.

6. The beverage system of claim 5 wherein at least one of the top wall, the front wall, and the back wall comprise a flat surface.

7. The beverage system of claim 1 wherein the set of walls includes at least three walls that independently movable with respect to each other.

8. The beverage system of claim 7 wherein the at least three walls are a top wall, a front wall, and a back wall.

9. The beverage system of claim 1 wherein the set of walls includes at least one movable wall defined by the closure.

10. The beverage system of claim 9 wherein the chamber is configured to receive pods of different sizes that differ with respect to each other by a single dimension.

11. The beverage system of claim 10 wherein the at least one movable wall translates along one direction to accommodate the pods of different sizes.

12. The beverage system of claim 1 wherein the brewer is configured to receive at least one pod that fits snug within the chamber when the closure is in the closed position.

13. The beverage system of claim 1 wherein the chamber has an extruded shape defined by the set of walls when in the closed position.

14. The beverage system of claim 13 wherein the extruded shape is a cuboid shape.

15. A beverage system comprising at least one pod of beverage material, the at least one pod comprising: a holder, a wrapper fully enclosing the holder, the wrapper defining an exterior of the at least one pod, wherein the exterior of the at least one pod is configured to be punctured to form an exterior inlet and an exterior outlet.

16. The beverage system of claim 15 wherein the holder has an extruded shape.

17. The beverage system of claim 16 wherein the holder comprises at least two flat sides parallel to each other.

18. The beverage system of claim 17 wherein the extruded shape is a cuboid shape.

19. The beverage system of claim 15 wherein the holder defines a rigid structure of the pod.

20. The beverage system of claim 15 wherein the holder includes at least one opening having at least a portion aligning with the exterior outlet to define a fluid outlet.

21. The beverage system of claim 15 wherein the holder includes at least one aperture having at least a portion aligning with the exterior inlet to define a fluid inlet.

22. The beverage system of claim 15 further comprising a filter portion within the holder wherein the holder comprises at least one safeguard device to protect the filter portion when the exterior is punctured.

23. The beverage system of claim 22 further comprising at least one opening in the holder that aligns with at least one of the exterior inlet or the exterior outlet and wherein the filter portion covers the at least one opening to seal the holder for holding the beverage material.

24. The beverage system of claim 22 wherein the filter portion is a filter pouch separated from and located within the holder, the filter pouch holding the beverage material.

25. The beverage system of claim 15 wherein the wrapper is a single piece of material that is unattached to the holder.

26. The beverage system of claim 25 wherein the wrapper is snug fit around the holder.

27. A beverage system comprising:
at least one pod with a holder and a wrapper fully enclosing the holder, the wrapper defining an exterior of the at least one pod; and
a brewer having a chamber defined by a set of walls including a pair of sidewalls each comprising a flat surface; and a closure movable between an open position allowing access to the chamber and a closed position closing access to the chamber;
wherein the brewer is configured to puncture the exterior of the at least one pod when the closure is moved from the opened position to the closed position to form an exterior inlet and an exterior outlet in the exterior of the at least one pod.

28. The beverage system of claim 27 wherein the holder has an extruded shape.

29. The beverage system of claim 27 wherein the at least one pod further comprises a set of end seals and wherein the set of walls comprise at least one ramped portion configured to press against the set of end seals to form a snug fit within the chamber.

30. The beverage system of claim 27 wherein the at least one pod has a cuboid shape.

31. The beverage system of claim 27 wherein the chamber further comprises a recess housing a set of cutters.

32. The beverage system of claim 31 wherein the set of cutters is located in a bottom wall of the chamber and has a changeable configuration for varying a number of exterior outlets pierced into the pod.

33. The beverage system of claim 31 wherein the set of cutters is a set of stationary cutters configured to puncture the wrapper as the wrapper expands to define the exterior outlet.

34. The beverage system of claim 27 wherein the holder comprises a pattern of openings for controlling an internal pressure of the pod.

35. The beverage system of claim 27 wherein the holder comprises a pattern of openings for controlling a flow of liquid within the holder.
